(19) United States
(12) Patent Application Publication
(10) Pub. No.: US 2022/0398134 A1
(43) Pub. Date: Dec. 15, 2022

(54) ALLOCATION OF SERVICES TO CONTAINERS

(71) Applicant: International Business Machines Corporation, Armonk, NY (US)

(72) Inventors: Peng Hui Jiang, Beijing (CN); Yue Wang, Beijing (CN); Wei Wu, Beijing (CN); Yang Pei, Shangdi (CN)

(21) Appl. No.: 17/345,692

(22) Filed: Jun. 11, 2021

(51) Int. Cl. G06F 9/50

(52) U.S. Cl. CPC G06F 9/5038; G06F 9/5077

(57) ABSTRACT

A method, a device and a computer program product for service allocation are proposed. In the method, a first allocation scheme for allocating a set of services to a set of containers is determined based on respective measurements of a plurality of service attributes related to each of the set of services in execution and respective importance levels of the plurality of service attributes. For a container of the set of containers, respective total measurements of the plurality of service attributes related to at least one of the set of services to be allocated to the container in the first allocation scheme are determined. In accordance with a determination that a total measurement of the respective total measurements exceeds a corresponding measurement threshold, the respective importance levels for use in determining a further allocation scheme for allocating the set of services are updated.

### BACKGROUND

The present disclosure relates to information processing, and more specifically, to a method, system, and computer program product for allocating services to containers.

With the evolution of the database, such as the DBaaS (DataBase-as-a-Service), the function set of the database is divided into a plurality of services, such as CRUD (creating, reading, updating and deleting), index building, index searching, database replication, database backup, and the like. In this case, in order to complete one transaction, a plurality of services on different pods or containers need to be called with a call chain. In addition, the database can be utilized by a plurality of tenants with different sizes at different levels. Such evolution also brings about new issues to be solved. However, the traditional database is inefficient in dealing with these issues.

### SUMMARY

According to a first aspect of the present disclosure, there is provided a computer-implemented method. According to the method, a first allocation scheme for allocating a set of services to a set of containers is determined based on respective measurements of a plurality of service attributes related to each service of the set of services in execution and respective importance levels of the plurality of service attributes. For a container of the set of containers, respective total measurements of the plurality of service attributes related to at least one service of the set of services to be allocated to the container in the first allocation scheme are determined. In accordance with a determination that a total measurement of the respective total measurements exceeds a corresponding measurement threshold, the respective importance levels for use in determining a further allocation scheme for allocating the set of services are updated.

According to a second aspect of the present disclosure, there is provided a system. The system comprises a processing unit and a memory coupled to the processing unit and storing instructions thereon. The instructions, when executed by the processing unit, perform acts including: determining a first allocation scheme for allocating a set of services to a set of containers based on respective measurements of a plurality of service attributes related to each service of the set of services in execution and respective importance levels of the plurality of service attributes; for a container of the set of containers, determining respective total measurements of the plurality of service attributes related to at least one service of the set of services to be allocated to the container in the first allocation scheme; and in accordance with a determination that a total measurement of the respective total measurements exceeds a corresponding measurement threshold, updating the respective importance levels for use in determining a further allocation scheme for allocating the set of services.

According to a third aspect of the present disclosure, there is provided a computer program product comprising a computer-readable storage medium having program instructions embodied therewith. The program instructions are executable by a processor to cause the processor to perform acts of: determining a first allocation scheme for allocating a set of services to a set of containers based on respective measurements of a plurality of service attributes related to each service of the set of services in execution and respective importance levels of the plurality of service attributes; for a container of the set of containers, determining respective total measurements of the plurality of service attributes related to at least one service of the set of services to be allocated to the container in the first allocation scheme; and in accordance with a determination that a total measurement of the respective total measurements exceeds a corresponding measurement threshold, updating the respective importance levels for use in determining a further allocation scheme for allocating the set of services.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present disclosure.

FIG. 2 depicts a cloud computing environment according to an embodiment of the present disclosure.

FIG. 3 depicts abstraction model layers according to an embodiment of the present disclosure.

FIG. 4 depicts a schematic diagram of an example of a service allocation environment in which an embodiment of the present disclosure can be implemented.

FIG. 5 depicts a schematic diagram of an example of a hierarchical relationship of a set of services according to an embodiment of the present disclosure.

FIG. 6 depicts a flowchart of an example of a method for service allocation according to an embodiment of the present disclosure.

FIG. 7 depicts a schematic diagram of an example of respective measurements of a plurality of service attributes according to an embodiment of the present disclosure.

FIG. 8 depicts a schematic diagram of an example of a first allocation scheme according to an embodiment of the present disclosure.

FIG. 9 depicts a schematic diagram of an example of a second allocation scheme according to an embodiment of the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

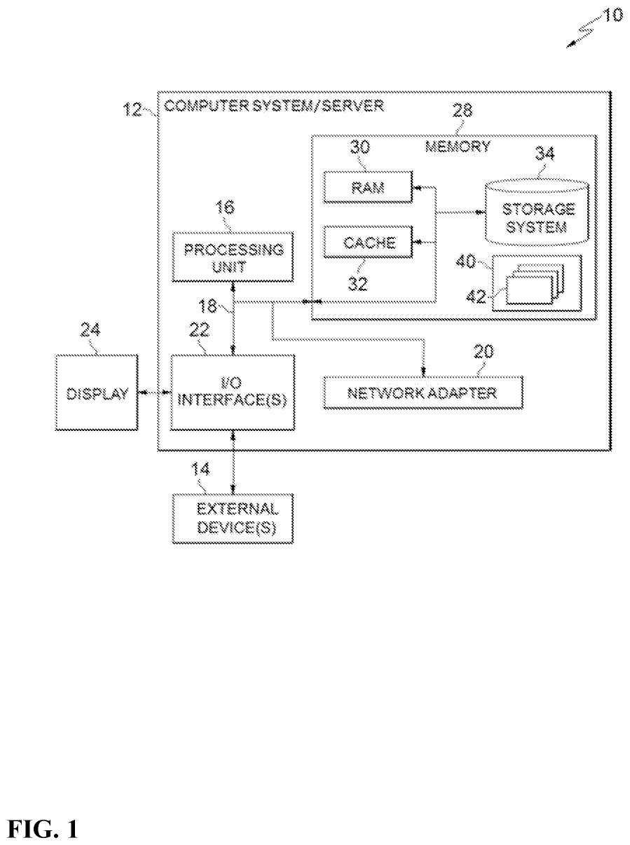

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

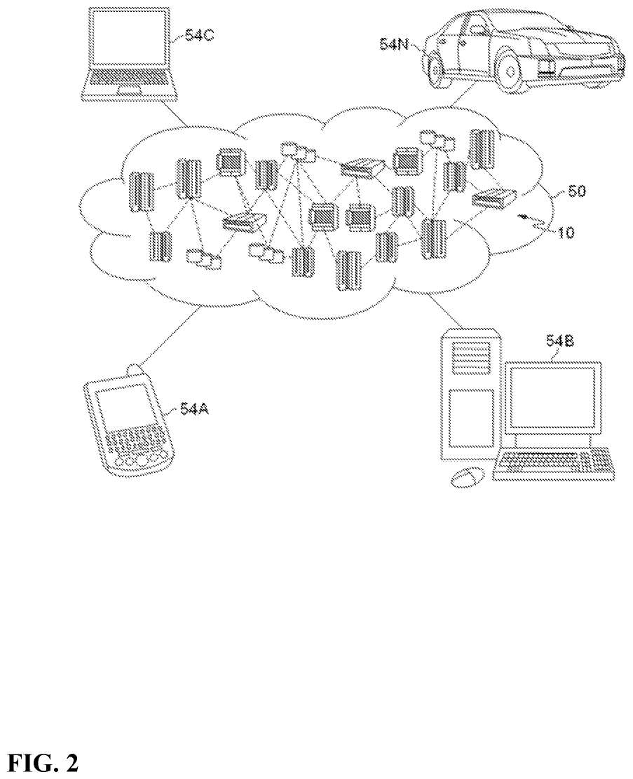

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

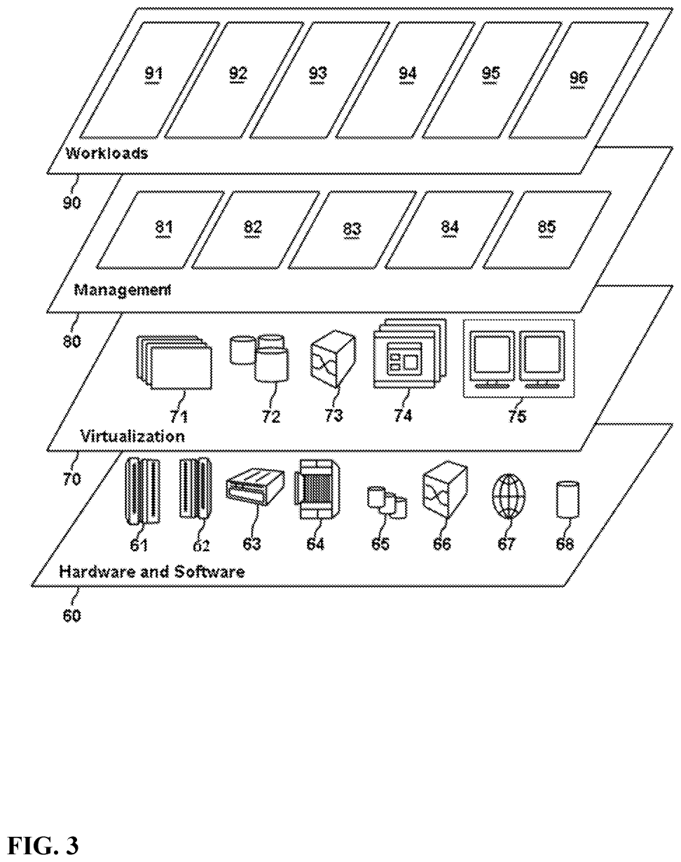

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and service allocation 96.

Many known configurations of DataBase-as-a-Service (DBaaS) include a functional set of databases divided into multiple micro services, including, and without limitation, creating-reading-updating-deleting (CRUD) features, indexing build, index search, database replication, and database backup. In order to complete one job, multiple database services on different pods or within different containers will be called within one call-chain. In addition, there are typically multiple tenants with different-sized processing requirements to consume DBaaS at different levels. Generally, the scheduling of these database-related tasks is executed through the services that are providing the platform, where such scheduling may not always be optimized to consider the hierarchical relationship of the respective web service call-chain to allocate the pod or container topology. Moreover, due to the lack of analysis of the respective database's operating characteristics, sometimes the most effective use of computing resources is not achieved.

As described above, the evolution of the database brings about new issues to be solved. However, the traditional database is inefficient in dealing with these issues. For example, one issue to be solved is how to leverage the service attributes of the database to provision different types of pods/containers, so as to provide different typologies or combinations of the pods/containers. Another issue is how to dynamically adjust the typology of the pods/containers along with the change of workloads or tenants. In addition, a further issue is how to reduce cost for providing and adjusting the typology of the pods/containers in an acceptable time with high fault toleration.

As a specific example, a typical transaction in the database may include obtaining target data, filtering expected subsets from the data obtained, aggregating these subsets to a consolidated dataset, and replicating the dataset into a target storage. Traditionally, it is difficult to optimize the typology of the pods/containers in consideration of the different workloads of the different services and the hierarchical relationship of the services.

At least one known mechanism for more effectively using the computing resources includes regulating the capacity of the computing system through managing the resources directly through, for example, delaying the execution of certain database work to regulate the capacity of the database system. Similarly, another known mechanism includes determining the resource requirements for a job, assigning the job to a classification, and prioritizing the execution of the jobs based on the assigned classification. However, clients of DBaaS may object to intentional delays of their respective processing requests. Moreover, there are known methods to manage container-based resource reallocation during periods of abnormal resource performance; however, such reallocation mechanisms are not configured for normal operation. In addition, some known methods and systems rely on the collection of resource usage history for particular tasks and, combined with task deadlines, to schedule the tasks appropriately. Similarly, some methods rely on real-time resource usage; however, these methods do not take into account other properties of the tasks that may provide for further enhancement of efficient task scheduling and execution. Furthermore, at least some methods focus on other attributes and considerations, such as, prioritizing certain requests according to maximizing business values based on the types of information being processed and characteristics of the customers, the affected services, the computing environment, and workflow information; however, such methods do not focus on optimizing computing resource allocation to the tasks.

An improved solution for service allocation is provided in this disclosure. Generally speaking, according to embodiments of the present disclosure, a first allocation scheme for allocating a set of services to a set of containers is determined based on respective measurements of a plurality of service attributes related to each of the set of services in execution and respective importance levels of the plurality of service attributes. For a container of the set of containers, respective total measurements of the plurality of service attributes related to at least one of the set of services to be allocated to the container in the first allocation scheme are determined. In accordance with a determination that a total measurement of the respective total measurements exceeds a corresponding measurement threshold, the respective importance levels for use in determining a further allocation scheme for allocating the set of services are updated.

In accordance with the service allocation mechanism as proposed herein, a set of services can be efficiently allocated to a set of containers in an acceptable time with high fault toleration and low cost.

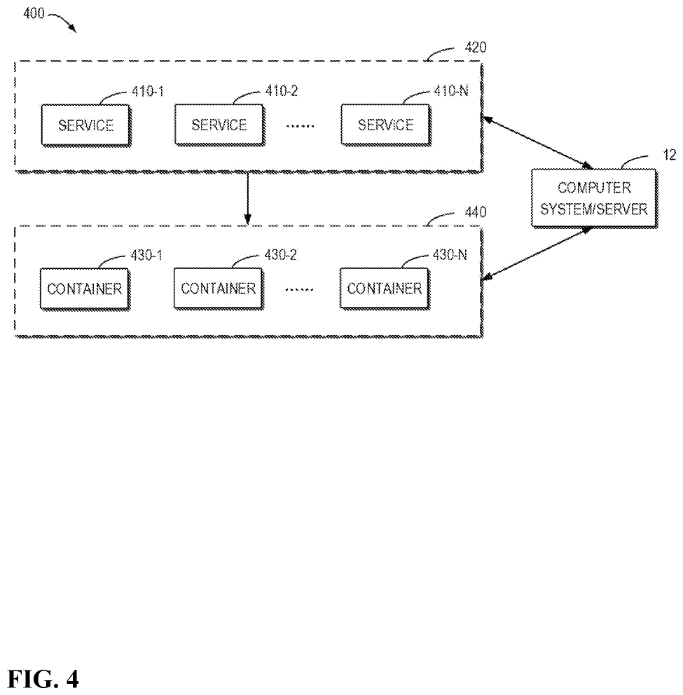

Now some example embodiments will be described with reference to FIGS. 4-9. FIG. 4 depicts a schematic diagram of an example of a service allocation environment 400 in which an embodiment of the present disclosure can be implemented.

The service allocation environment 400 may include the computer system/server 12, a set of services 420, and a container pool 440. The set of services 420 may include a plurality of services, such as services 410-1 to 410-N (collectively referred to as “services 410” or individually referred to as “service 410”, where N represents a positive integer larger than 1). For example, these services may include an index service, a filter service, an aggregation service, a replication service, a CRUD service, a full text service, a backup service, and the like.

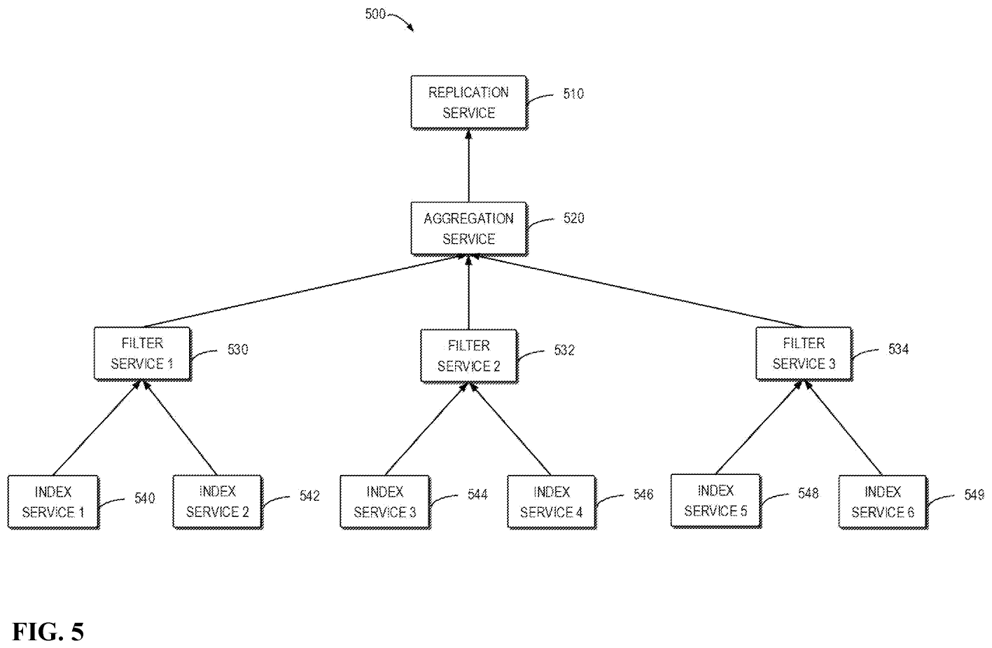

As a specific example, when completing a transaction in the database, a set of services may be called in a chain, such that the services can be organized in a hierarchy. FIG. 5 depicts a schematic diagram of an example of hierarchical relationship 500 of a set of services according to an embodiment of the present disclosure. As shown in FIG. 5, in order to complete a transaction in the database, the index services 540, 542, 544, 546, 548, and 549 may be called to obtain target data. For instance, the index service may be a Map/Reduce service that searches for the target data by the index of the data. Alternatively, the index service may be a full text service that searches the entire text for the data.

In addition, the filter services 530, 532, and 534 may be called to filter expected subsets from the data obtained. For example, the data can be filtered according to a specified condition, such as the data source, the time when the data is generated, or the like. The aggregation service 520 may aggregate these subsets to a consolidated dataset. The replication service 510 may replicate the dataset into a target storage.

Returning back to FIG. 4, the container pool 440 may include a plurality of containers, such as containers 430-1 to 430-M (collectively referred to as “containers 430” or individually referred to as “container 430”, where M represents a positive integer larger than 1). The computer system/server 12 may allocate the set of services 420 to a set of containers selected from the container pool 440 for execution.

In some embodiments, a pod may initiate one or more containers 430. A pod is an independent logic machine, which has its own IP address, host name, processes, proxy, or the like. In this event, all containers 430 in a pod are in an independent logic machine. Thus, allocation of the set of services 420 to a set of containers can also be regarded as allocation of the set of services 420 to a set of pods.

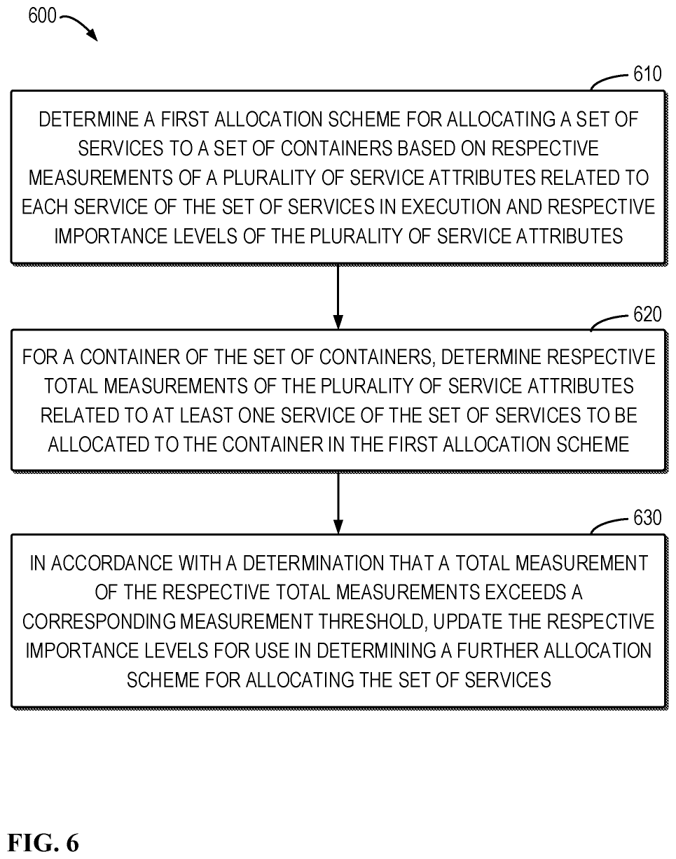

The allocation of the set of services 420 to a set of containers will be described in more detail below with reference to FIGS. 6-9. FIG. 6 depicts a flowchart of an example of a method 600 for service allocation according to an embodiment of the present disclosure. At 610, the computer system/server 12 determines a first allocation scheme for allocating a set of services 420 to a set of containers based on respective measurements of a plurality of service attributes related to each of the set of services 420 in execution and respective importance levels of the plurality of service attributes.

In some embodiments, the set of services 420 may be executed in respective containers in the container pool 440. In this case, the computer system/server 12 may obtain the respective measurements of a plurality of service attributes related to each of the set of services 420 by monitoring and tracing the respective containers currently executing the set of services.

In some embodiments, the service attributes may include a processing resource, a memory resource, a response time, a network resource, a storage resource, a failure ratio, a retry ratio, a message queue length, and a load balance condition. For example, the processing resource may be the CPU, GPU (Graphics Processing Unit), or the like. The memory resource may be the SDRAM (Synchronous Dynamic Random Access Memory), DDR SDRAM (Double Data Rate SDRAM), or the like. The response time may be the response time of the service since the service is called. The network resource may be the network bandwidth, the network traffic, or the like. The storage resource may be the disk, the persistent volume, or the like. The failure ratio and retry ratio may be the ratio of the failure and retry of the data transmission due to the poor network condition, for example. The message queue length may be the number of messages queuing for processing by the service. The load balance condition may be the number of connections, the number of messages transmitted, or the like.

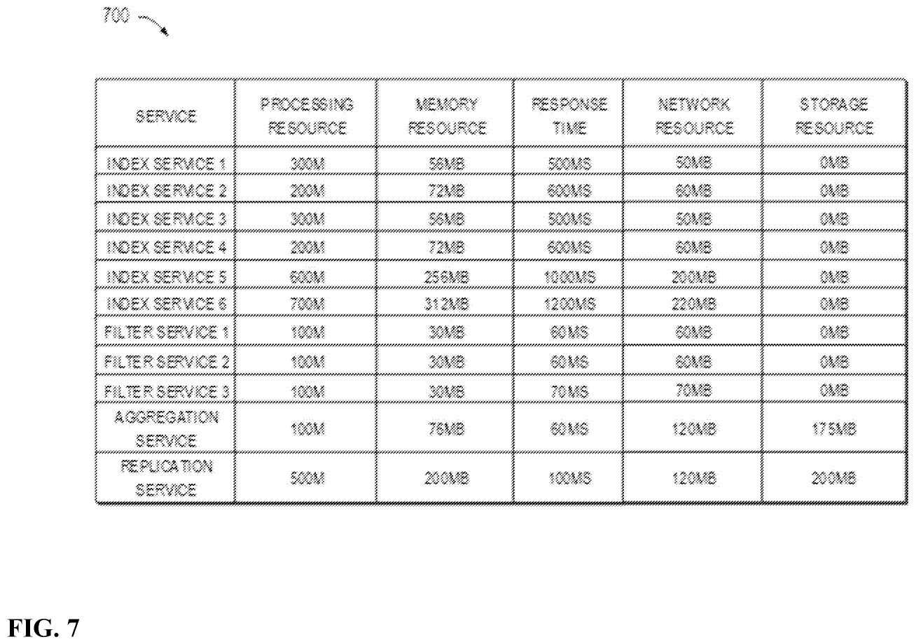

FIG. 7 depicts a schematic diagram of an example of respective measurements 700 of a plurality of service attributes according to an embodiment of the present disclosure. FIG. 7 shows the respective measurements of the service attributes (including the processing resource, the memory resource, the response time, the network resource, and the storage resource) related to the index services 540, 542, 544, 546, 548, and 549, the filter services 530, 532, and 534, the aggregation service 520, and the replication service 510. For example, as shown in FIG. 7, for the index service 1, the respective measurements of the processing resource, the memory resource, the response time, the network resource and the storage resource are 300 M (millicore), 56 MB (Mega Byte), 500 MS (millisecond), 50 MB and 0 MB, respectively.

Returning back to FIG. 6, in addition to the respective measurements of the plurality of service attributes, the computer system/server 12 may also obtain respective importance levels of the plurality of service attributes. For example, the importance levels of the processing resource, the memory resource, the response time, the network resource, and the storage resource may be 30%, 30%, 20%, 10% and 10%, respectively. The importance levels may be predetermined. For example, initially, the importance levels may be randomly determined or determined based on the historical experience. In addition, the importance levels may be determined in the prior iteration.

Thereby, the first allocation scheme may be determined based on the respective measurements of the plurality of service attributes and the respective importance levels. In some embodiments, in order to determine the first allocation scheme, the computer system/server 12 may determine a service score for each of the set of services based on the respective measurements of the plurality of service attributes and the respective importance levels. In some embodiments, the service score may be a sum of each of the respective measurements weighted by the corresponding importance level.

For example, for the index service 1, the respective measurements of the processing resource, the memory resource, the response time, the network resource and the storage resource are 300 M, 56 MB, 500 MS, 50 MB, and 0 MB, respectively. The respective importance levels of the processing resource, the memory resource, the response time, the network resource and the storage resource may be 30%, 30%, 20%, 10%, and 10%, respectively. In this case, the service score for the index service 1 can be calculated as: 300*30%+56*30%+500*20%+50*10%+0*10%=211.8.

In some embodiments, the computer system/server 12 may normalize the respective measurements of the plurality of service attributes, and determine the service score based on the normalized respective measurements. For example, the computer system/server 12 may determine a maximum measurement of each of the plurality of service attributes. For instance, the maximum measurement of the processing resource is 700 M. In this case, the computer system/server 12 may normalize the measurements of the processing resource with the maximum measurement. For example, the normalized measurement of the processing resource for the index service 1 can be calculated as: 300/700≈0.43.

Thereby, the computer system/server 12 may determine the first allocation scheme based on a comparison between respective service scores for the set of services and respective score thresholds associated with a plurality of candidate containers. In some embodiments, the computer system/server 12 may determine a total service score related to one or more services selected from the set of services 420 based on one or more of the respective service scores for the one or more services.

For example, it is assumed that the service scores for the index services 540, 542, 544, 546, 548, and 549, the filter services 530, 532, and 534, the aggregation service 520, and the replication service 510 are 20, 25, 25, 25, 40, 40, 5, 5, 5, 5, and 75, respectively. In this case, the total service score related to the index services 540, 542, 544, and 546 is 95. The total service score related to the index services 548 and 549 is 80. The total service score related to the filter services 530, 532, and 534 and the aggregation service 520 is 20. The total service score related to the replication service 510 is 75.

If the total service score is below or equal to a target score threshold of the respective score thresholds associated with a target container selected from the plurality of candidate containers, the computer system/server 12 may determine the first allocation scheme to indicate that the one or more services are to be allocated to the target container. It should be understood that, the score thresholds for different target containers may be the same or different. For example, the score thresholds associated with four target containers may be 100.

In this case, since the total service score related to the index services 540, 542, 544, and 546, the total service score related to the index services 548 and 549, the total service score related to the filter services 530, 532, and 534 and the aggregation service 520, and the total service score related to the replication service 510 are below or equal to the target score threshold 100, the computer system/server 12 may determine the first allocation scheme to indicate that the index services 540, 542, 544, and 546 are to be allocated to a first target container, the index services 548 and 549 are to be allocated to a second target container, the filter services 530, 532, and 534 and the aggregation service 520 are to be allocated to a third target container, and the replication service 510 are to be allocated to a fourth target container.

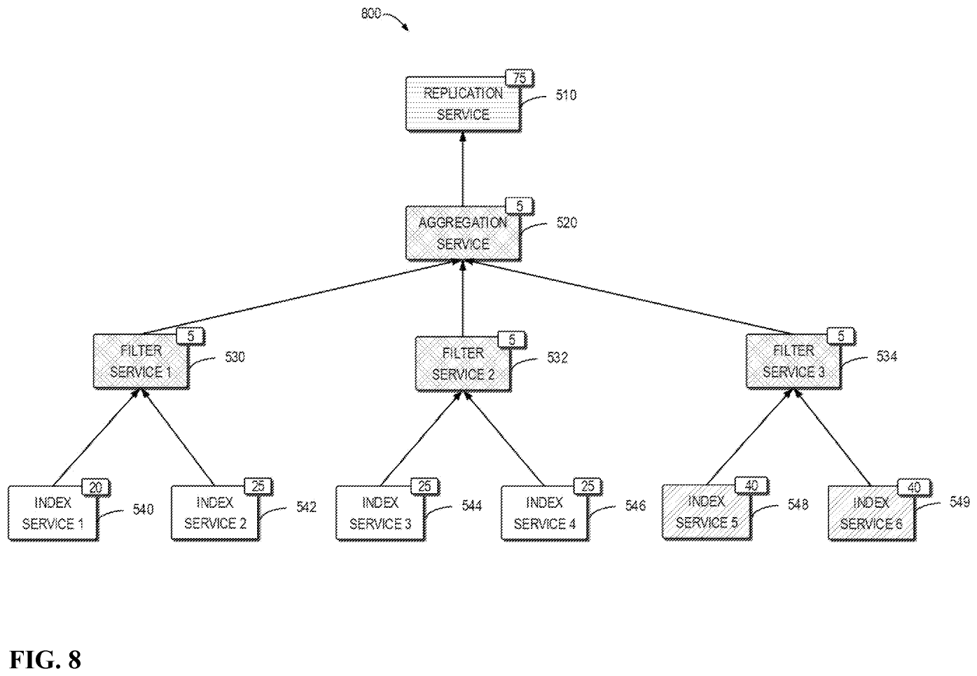

FIG. 8 depicts a schematic diagram of an example of a first allocation scheme 800 according to an embodiment of the present disclosure. As shown in FIG. 8, the service scores for the index services 540, 542, 544, 546, 548, and 549, the filter services 530, 532, and 534, the aggregation service 520 and the replication service 510 are 20, 25, 25, 25, 40, 40, 5, 5, 5, 5, and 75, respectively. In the first allocation scheme, the index services 540, 542, 544, and 546 are to be allocated to a first target container, the index services 548 and 549 are to be allocated to a second target container, the filter services 530, 532, and 534 and the aggregation service 520 are to be allocated to a third target container, and the replication service 510 are to be allocated to a fourth target container.

Returning back to FIG. 6, in some embodiments, some services are not allowed to be allocated to a same container, or some services are preferred to be allocated to a same container. In this case, the affinity and anti-affinity of the services need to be considered. For example, the computer system/server 12 may obtain affinity information. The affinity information may indicate whether at least two of the set of services are allowed to be allocated to a same container. In addition, in some embodiments, some container is not allowed to cooperate with another container. In this case, the affinity and anti-affinity of the containers also need to be considered. In this event, the affinity information may also indicate whether at least two containers in the container pool 440 are allowed to corporate with each other.

Thereby, the computer system/server 12 may determine the first allocation scheme further based on the affinity information. In this way, in addition to the measurements and the importance levels, the first allocation scheme can be further optimized in consideration of the affinity information.

The above text describes the coarse determination of the first allocation scheme, and the fine determination of the second allocation scheme will be described in detail below.

In some embodiments, although the total service scores related to the one or more services to be allocated to a target container is below or equal to the corresponding target score threshold, the total measurement of a particular service attribute may exceed the corresponding measurement threshold. For example, it is assumed that the total measurement of the processing resource related to the index services 540, 542, 544, and 546 to be allocated to the first target container is 1000 M. However, the measurement threshold associated with the processing resource of the first target container is 800 M. In this case, the first target container supports the execution of the index services 540, 542, 544, and 546. Thus, the first allocation scheme need to be adjusted.

In this case, at 620, for a container of the set of containers, the computer system/server 12 determines respective total measurements of the plurality of service attributes related to at least one of the set of services 420 to be allocated to the container in the first allocation scheme. If the respective total measurements for each of the set of containers are below or equal to corresponding measurement thresholds associated with each of the set of containers, the computer system/server 12 may allocate the set of services 420 to the set of containers for execution based on the first allocation scheme.

If a total measurement of the respective total measurements exceeds a corresponding measurement threshold, at 630, the computer system/server 120 may update the respective importance levels for use in determining a further allocation scheme for allocating the set of services 420. In some embodiments, if the total measurement exceeds the corresponding measurement threshold associated with one of the plurality of service attributes, the computer system/server 120 may increase an importance level of the respective importance levels associated with the service attribute. In addition, in some embodiments, the computer system/server 120 may also decrease importance levels of the respective importance levels associated with remaining service attributes of the plurality of service attributes other than the service attribute.

For example, it is assumed that the total measurement of the processing resource related to the index services 540, 542, 544, and 546 to be allocated to the first target container is 1000 M. However, the measurement threshold associated with the processing resource of the first target container is 800 M. The total measurement of the processing resource exceeds the measurement threshold. In this case, the importance levels may be updated. In particular, the importance level for the processing resource may be increased.

It is assumed that the importance levels for the processing resource, the memory resource, the response time, the network resource and the storage resource may be 30%, 30%, 20%, 10%, and 10%, respectively. The updated importance levels for the processing resource, the memory resource, the response time, the network resource and the storage resource may be 40%, 25%, 15%, 10%, and 10%, respectively. It can be seen that, the importance level for the processing resource is increased, while the importance levels for the memory resource and the response time are decreased.

In some embodiments, the computer system/server 120 may determine a second allocation scheme for allocating the set of services 420 to a second set of containers based on the respective measurements of the plurality of service attributes related to each of the set of services 420 and the respective updated importance levels associated with the plurality of service attributes. The determination of the second allocation scheme is similar to that of the first allocation scheme.

Specifically, in some embodiments, in order to determine the second allocation scheme, the computer system/server 12 may determine a service score for each of the set of services based on the respective measurements of the plurality of service attributes and the respective updated importance levels. In some embodiments, the service score may be a sum of each of the respective measurements weighted by the corresponding updated importance level.

For example, for the index service 1, the respective measurements of the processing resource, the memory resource, the response time, the network resource and the storage resource are 300 M, 56 MB, 500 MS, 50 MB, and 0 MB, respectively. The respective updated importance levels of the processing resource, the memory resource, the response time, the network resource and the storage resource may be 40%, 25%, 15%, 10%, and 10%, respectively. In this case, the service score for the index service 1 can be calculated as: 300*40%+56*25%+500*15%+50*10%+0*10%=214

In some embodiments, the computer system/server 12 may normalize the respective measurements of the plurality of service attributes, and determine the service score based on the normalized respective measurements and the respective updated importance levels.

Thereby, the computer system/server 120 may determine the second allocation scheme based on a comparison between respective service scores for the set of services 420 and respective score thresholds associated with a plurality of candidate containers. In some embodiments, the computer system/server 12 may determine a total service score related to one or more services selected from the set of services 420 based on one or more of the respective service scores for the one or more services.

For example, it is assumed that the service scores for the index services 540, 542, 544, 546, 548, and 549, the filter services 530, 532, and 534, the aggregation service 520 and the replication service 510 are 35, 35, 35, 35, 45, 45, 5, 5, 5, 5, and 85, respectively. In this case, the total service score related to the index services 540 and 542 is 70. The total service score related to the index services 544 and 546 is 70. The total service score related to the index services 548 and 549 is 90. The total service score related to the filter services 530, 532 and 534 and the aggregation service 520 is 20. The total service score related to the replication service 510 is 85.

If the total service score is below or equal to a target score threshold of the respective score thresholds associated with a target container selected from the plurality of candidate containers, the computer system/server 12 may determine the second allocation scheme to indicate that the one or more services are to be allocated to the target container. It should be understood that, the score thresholds for different containers may be the same or different. For example, the score thresholds associated with five target containers may be 100.

In this case, since the total service score related to the index services 540 and 542, the total service score related to the index services 544 and 546, the total service score related to the index services 548 and 549, the total service score related to the filter services 530, 532, and 534 and the aggregation service 520, and the total service score related to the replication service 510 are below or equal to the target score threshold 100, the computer system/server 12 may determine the second allocation scheme to indicate that the index services 540 and 542 are to be allocated to a first target container, the index services 544 and 546 are to be allocated to a second target container, the index services 548 and 549 are to be allocated to a third target container, the filter services 530, 532 and 534 and the aggregation service 520 are to be allocated to a fourth target container, and the replication service 510 are to be allocated to a fifth target container.

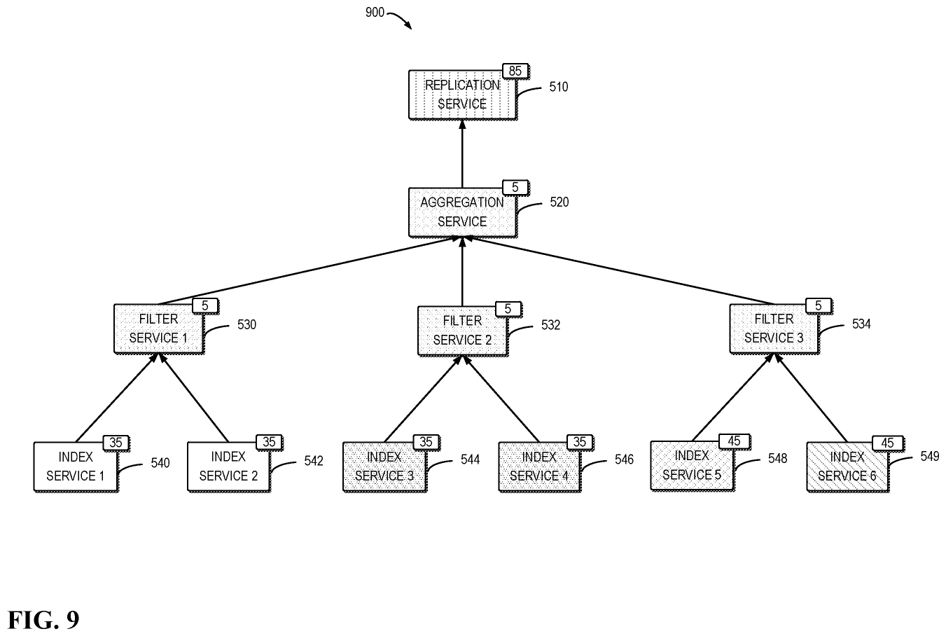

FIG. 9 depicts a schematic diagram of an example of a second allocation scheme 900 according to an embodiment of the present disclosure. As shown in FIG. 9, the service scores for the index services 540, 542, 544, 546, 548, and 549, the filter services 530, 532 and 534, the aggregation service 520 and the replication service 510 are 35, 35, 35, 35, 45, 45, 5, 5, 5, 5, and 85, respectively. In the second allocation scheme, the index services 540 and 542 are to be allocated to a first target container, the index services 544 and 546 are to be allocated to a second target container, the index services 548 and 549 are to be allocated to a third target container, the filter services 530, 532, and 534 and the aggregation service 520 are to be allocated to a fourth target container, and the replication service 510 is to be allocated to a fifth target container.

Returning back to FIG. 6, in some embodiment, the computer system/server 12 may determine the second allocation scheme further based on the affinity information. In this way, in addition to the measurements and the updated importance levels, the second allocation scheme can be optimized further in consideration of the affinity information.

In some embodiments, the time for determining an optimal/best allocation scheme may be very long. For example, the time for determining an optimal allocation scheme may cost several minutes. In this case, instead of determining the optimal allocation scheme of all the possible allocation schemes, the computer system/server 12 may determine a suboptimal allocation scheme within a predetermined time, such as 5 seconds. In this case, the efficiency of determining the allocation scheme can be improved.

Thereby, the computer system/server 12 may allocate the set of services 420 to the second set of containers for execution based on the second allocation scheme. In this way, the set of services 420 can be efficiently allocated to a set of containers in an acceptable time with high fault toleration and low cost.

In addition, in some cases, a plurality of services with different priority may be allocated to a same container. For example, different users with different priorities may use the database. A first user may be of a high priority, while the second user may be of a low priority. That is to say, the services of the first user may have a high priority, while the services of the second user may have a low priority. In this case, a mechanism for prioritizing the services of the second user over the services of the first user may be provided.

Thereby, in some embodiments, if a plurality of services in the set of services 420 are allocated to a container of the set of containers, for a service attribute of the plurality of service attributes, the computer system/server 12 may determine a further total measurement of the service attribute related to the plurality of services. If the further total measurement exceeds a further corresponding measurement threshold, the computer system/server 12 may allocate at least one of the plurality of services to at least one further container. The at least one of the plurality services has a lower priority than at least one remaining service of the plurality of services.

For example, it is assumed that the further total measurement of the processing resource related to the plurality of services is 1000 M. However, the further measurement threshold associated with the processing resource of the first target container is 600 M. In this case, the services with a lower priority may be allocated to at least one further container. For example, the services of the first user with the low priority may be allocated to at least one further container. In this way, the user experience of the second user with the high priority can be improved.

Further, in some cases, a single service may be unable to be executed in one container. For example, the measurement of the processing resource of a service may be very large, and one container cannot support the execution of this service. In this case, this service may be split into several micro-services.

Specifically, in some embodiments, if a measurement of the respective measurements related to a first service of the set of services 420 exceeds the corresponding measurement threshold, the computer system/server 12 may split the first service into a plurality of services. For example, the first service may be split into multiple sub-services or micro-services. Thereby, the computer system/server 12 may determine a third allocation scheme for allocating the plurality of services and remaining services in the set of services 420 other than the first service. As such, the size of the services may be dynamically adjusted with the capability of the containers.

The above described processes (such as, the obtaining of the measurements, the coarse and fine determination of the allocation schemes and the allocation of the services to the containers) can be iteratively performed. In this case, the allocation of the services to the containers can be dynamically adjusted.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining a first allocation scheme for allocating a set of services to a set of containers based on respective measurements of a plurality of service attributes related to each service of the set of services in execution and respective importance levels of the plurality of service attributes;
for a container of the set of containers, determining respective total measurements of the plurality of service attributes related to at least one service of the set of services to be allocated to the container in the first allocation scheme; and
in accordance with a determination that a total measurement of the respective total measurements exceeds a corresponding measurement threshold, updating the respective importance levels for use in determining a further allocation scheme for allocating the set of services.

2. The method of claim 1, further comprising:
in accordance with a determination that the respective total measurements for each container of the set of containers are below or equal to corresponding measurement thresholds associated with each container of the set of containers, allocating the set of services to the set of containers for execution based on the first allocation scheme.

3. The method of claim 1, further comprising:
determining a second allocation scheme for allocating the set of services to a second set of containers based on the respective measurements of the plurality of service attributes related to each service of the set of services and the respective updated importance levels associated with the plurality of service attributes.

4. The method of claim 1, wherein determining the first allocation scheme comprises:
determining a service score for each service of the set of services based on the respective measurements of the plurality of service attributes and the respective importance levels; and
determining the first allocation scheme based on a comparison between respective service scores for the set of services and respective score thresholds associated with a plurality of candidate containers.

5. The method of claim 4, wherein determining the first allocation scheme based on a comparison between the respective service scores and the respective score thresholds comprises:
determining a total service score related to one or more services selected from the set of services based on one or more of the respective service scores for the one or more services; and
in accordance with a determination that the total service score is below or equal to a target score threshold of the respective score thresholds associated with a target container selected from the plurality of candidate containers, determining, the first allocation scheme to indicate that the one or more services are to be allocated to the target container.

6. The method of claim 1, wherein determining the first allocation scheme comprises:
obtaining affinity information associated with the set of services, the affinity information indicating whether at least two services of the set of services are allowed to be allocated to a same container; and
determining the first allocation scheme further based on the affinity information.

7. The method of claim 1, wherein updating the respective importance levels comprises:
in accordance with a determination that the total measurement exceeds the corresponding measurement threshold associated with one service attribute of the plurality of service attributes, increasing, by the one or more processors, an importance level of the respective importance levels associated with the service attribute.

8. The method according to claim 1, wherein the plurality of service attributes include at least two of:
a processing resource;
a memory resource;
a response time;
a network resource;
a storage resource;
a failure ratio;
a retry ratio;
a message queue length; and
a load balance condition.

9. The method of claim 1, further comprising:
in accordance with a plurality of services in the set of services are allocated to the container of the set of containers, for a service attribute of the plurality of service attributes, determining a further total measurement of the service attribute related to the plurality of services; and
in accordance with a determination that the further total measurement exceeds a further corresponding measurement threshold, allocating at least one service of the plurality of services to at least one further container, the at least one service of the plurality services having a lower priority than at least one remaining service of the plurality of services.

10. The method of claim 1, further comprising:
in accordance with a determination that a measurement of the respective measurements related to a first service of the set of services exceeds the corresponding measurement threshold, splitting the first service into a plurality of services; and
determining a third allocation scheme for allocating the plurality of services and remaining services in the set of services other than the first service.

11. A system, comprising:
a processing unit; and
a memory coupled to the processing unit and storing instructions thereon, the instructions, when executed by the processing unit, performing acts including:
determining a first allocation scheme for allocating a set of services to a set of containers based on respective measurements of a plurality of service attributes related to each service of the set of services in execution and respective importance levels of the plurality of service attributes;
for a container of the set of containers, determining respective total measurements of the plurality of service attributes related to at least one service of the set of services to be allocated to the container in the first allocation scheme; and
in accordance with a determination that a total measurement of the respective total measurements exceeds a corresponding measurement threshold, updating the respective importance levels for use in determining a further allocation scheme for allocating the set of services.

12. The system of claim 11, wherein the acts further comprises:
in accordance with a determination that the respective total measurements for each container of the set of containers are below or equal to corresponding measurement thresholds associated with each container of the set of containers, allocating the set of services to the set of containers for execution based on the first allocation scheme.

13. The system of claim 11, wherein the acts further comprises:
determining a second allocation scheme for allocating the set of services to a second set of containers based on the respective measurements of the plurality of service attributes related to each service of the set of services and the respective updated importance levels associated with the plurality of service attributes.

14. The system of claim 11, wherein determining the first allocation scheme comprises:
determining a service score for each service of the set of services based on the respective measurements of the plurality of service attributes and the respective importance levels; and
determining the first allocation scheme based on a comparison between respective service scores for the set of services and respective score thresholds associated with a plurality of candidate containers.

15. The system of claim 14, wherein determining the first allocation scheme based on a comparison between the respective service scores and the respective score thresholds comprises:
determining a total service score related to one or more services selected from the set of services based on one or more of the respective service scores for the one or more services; and
in accordance with a determination that the total service score is below or equal to a target score threshold of the respective score thresholds associated with a target container selected from the plurality of candidate containers, determining the first allocation scheme to indicate that the one or more services are to be allocated to the target container.

16. The system of claim 11, wherein determining the first allocation scheme comprises:
obtaining affinity information associated with the set of services, the affinity information indicating whether at least two of the set of services are allowed to be allocated to a same container; and
determining the first allocation scheme further based on the affinity information.

17. The system of claim 11, wherein updating the respective importance levels comprises:
in accordance with a determination that the total measurement exceeds the corresponding measurement threshold associated with one service attribute of the plurality of service attributes, increasing an importance level of the respective importance levels associated with the service attribute.

18. The system according to claim 11, wherein the plurality of service attributes include at least two of:
a processing resource;
a memory resource;
a response time;
a network resource;
a storage resource;
a failure ratio;
a retry ratio;
a message queue length; and
a load balance condition.

19. The system of claim 11, wherein the acts further comprises:
in accordance with a plurality of services in the set of services are allocated to the container of the set of containers, for a service attribute of the plurality of service attributes, determining a further total measurement of the service attribute related to the plurality of services; and
in accordance with a determination that the further total measurement exceeds a further corresponding measurement threshold, allocating at least one service of the plurality of services to at least one further container, the at least one service of the plurality services having a lower priority than at least one remaining service of the plurality of services.

20. A computer program product, comprising a computer-readable storage medium having program instructions embodied therewith, the program instructions executable by a processor to cause the processor to perform acts including:
determining a first allocation scheme for allocating a set of services to a set of containers based on respective measurements of a plurality of service attributes related to each service of the set of services in execution and respective importance levels of the plurality of service attributes;
for a container of the set of containers, determining respective total measurements of the plurality of service attributes related to at least one service of the set of services to be allocated to the container in the first allocation scheme; and
in accordance with a determination that a total measurement of the respective total measurements exceeds a corresponding measurement threshold, updating the respective importance levels for use in determining a further allocation scheme for allocating the set of services.
